(19) United States
(12) Patent Application Publication
(10) Pub. No.: US 2013/0338803 A1
(43) Pub. Date: Dec. 19, 2013

(54) ONLINE REAL TIME (ORT) COMPUTER BASED PREDICTION SYSTEM

(71) Applicant: California Institute of Technology, Pasadena, CA (US)

(72) Inventors: Uri MAOZ, LOS ANGELES, CA (US); Shengxuan YE, PASADENA, CA (US); Christof KOCH, SEATTLE, WA (US)

(21) Appl. No.: 13/921,118

(22) Filed: Jun. 18, 2013

Related U.S. Application Data
(60) Provisional application No. 61/661,163, filed on Jun. 18, 2012.

(51) Int. Cl. G07F 17/32

(52) U.S. Cl. CPC G07F 17/32
USPC 700/93

(57) ABSTRACT

An online real-time (ORT) system and method implementing such system for real-time prediction of one of two actions or classes of action are described. Such actions are detected by corresponding transducers configured to translate the actions to time varying amplitude signals.

### CROSS REFERENCE TO RELATED APPLICATIONS

The present application claims priority to U.S. Provisional Application No. 61/661,163, filed on Jun. 18, 2012, which is incorporated herein by reference in its entirety.

### STATEMENT OF FEDERAL GRANT

This invention was made with government support under SES0926544 awarded by National Science Foundation. The government has certain rights in the invention.

### FIELD

The present disclosure relates to computer based prediction system. More in particular, it relates to online real-time (ORT) computer based prediction system.

### SUMMARY

According to a first aspect of the disclosure, a method for obtaining a separation time window used for real-time prediction of one of two actions is provided. The method comprises, providing a plurality of transducers configured to collect an activity; coupling the plurality of transducers to a source of the activity; based on the coupling, capturing, through a computer, for each transducer of the plurality of transducers an electrical signal in correspondence of the activity prior to an action onset, where the action can be a first action or a second action associated to the activity and continuing capturing through the computer the electrical signal until the action is observed. The method further comprises, recording the action through the computer; repeating the capturing, continuing and recording; based on the repeating, collecting, through the computer, a plurality of captured electrical signals for each transducer; based on the collecting, filtering, through the computer, the plurality of captured electrical signals for each transducer; based on the filtering and the recording, detecting, through the computer, for each transducer a plurality of separation time windows in correspondence of the first action and the second action; based on the detecting, eliminating, through the computer, one or more separation time windows shorter than a corresponding minimum desired time and based on the eliminating, obtaining, through the computer, for each transducer one or more separation time windows, where each separation time window is larger than the corresponding minimum desired time.

### BRIEF DESCRIPTION OF THE DRAWINGS

FIGS. 1a, 1b and 2 show an exemplary online real-time (ORT) computer based prediction system.

FIG. 3 shows the ORT system's (as shown in the exemplary embodiments of FIGS. 1a and 2) training phase.

FIG. 4 shows the ORT system's (as shown in the exemplary embodiments of FIGS. 1a and 2) prediction phase.

FIG. 5 shows the prediction algorithm used in the ORT system to predict a movement, for example, a left/right hand movement.

FIG. 6 shows examples of decreasing degrees of left/right separations.

FIG. 7 shows the experimental setup in the clinic and the real-time system in action.

FIG. 8 shows across-subjects average accuracy of simulated-ORT versus time to predict.

FIG. 9 shows simulated-ORT accuracy for individual patients with no drop-off.

FIG. 10 shows an exemplary embodiment of a target hardware (e.g. a computer system) for implementing the embodiment of the analysis/stimulus computer processor and the associated analysis software (e.g. filtering, analysis and result interpretation), as shown in the exemplary embodiment of the ORT system of FIGS. 1a, 1b and 2.

### DETAILED DESCRIPTION

The ability to predict action content from neural signals in real-time before action onset has been long sought in the neuroscientific study of decision-making, agency and volition. A person skilled in the art would know that, current methods used for predicting action content from neural signals in real-time before action onset can rely on extracranial recording and may result in low accuracy even while the subjects are imagining the movement (or attempting to move for handicapped subjects). Using electrocorticography (EEG), these experiments [see, for example, references 1-4, incorporated herein by reference in their entirety] can measure brain potentials from subjects that are instructed to flex their wrist at a time of their choice and note the position of a rotating dot on a clock when they feel the urge to move.

The results obtained from such experiments suggests that a slow cortical wave measured over motor areas termed as “readiness potential” [see, for example, reference 5, incorporated herein by reference in its entirety], and known to proceed voluntary movement [see, for example, reference 6, incorporated herein by reference in its entirety], may begin a few hundred milliseconds before the average reported time of the urge to move. These experiments can suggest that action onset and contents could be decoded from preparatory motor signals in the brain before the subject becomes aware of an intention to move and of the contents of the action. However, in these experiments, the readiness potential can be assumed to be computed by averaging over 40 or more trials aligned to movement onset, after the fact.

More recently, it was shown that action contents can be decoded using functional magnetic-resonance imaging (fMRI) several seconds before movement onset [see, for example, reference 7, incorporated herein by reference in its entirety]. However, while done on a single-trial basis, decoding the neural signals takes place off-line, as the sluggish nature of fMRI hemodynamic signals precluded real-time analysis. Moreover, the above studies focused on arbitrary and meaningless action purposelessly raising the left or right hand, while the exemplary embodiments of the present disclosure are designed to investigate prediction of reasoned action in more realistic, everyday situations, with consequences for the subject.

Intracranial recordings in humans, on the other hand, can be useful for single-trial, on-line real-time (ORT) analysis of action onset and contents [see, for example, references 8 and 9, incorporated herein by reference in their entirety], because of the tight temporal pairing of local field potential (LFP) to the underlying neuronal signals. Moreover, intracranial recordings (e.g. via intracranial transducers) in humans are known to be cleaner and more robust in the art, with signal-to-noise ratios up to, for example, 100 times larger than surface recordings like, for example, EEG [see, for example, references 10 and 11, incorporated herein by reference in their entirety].

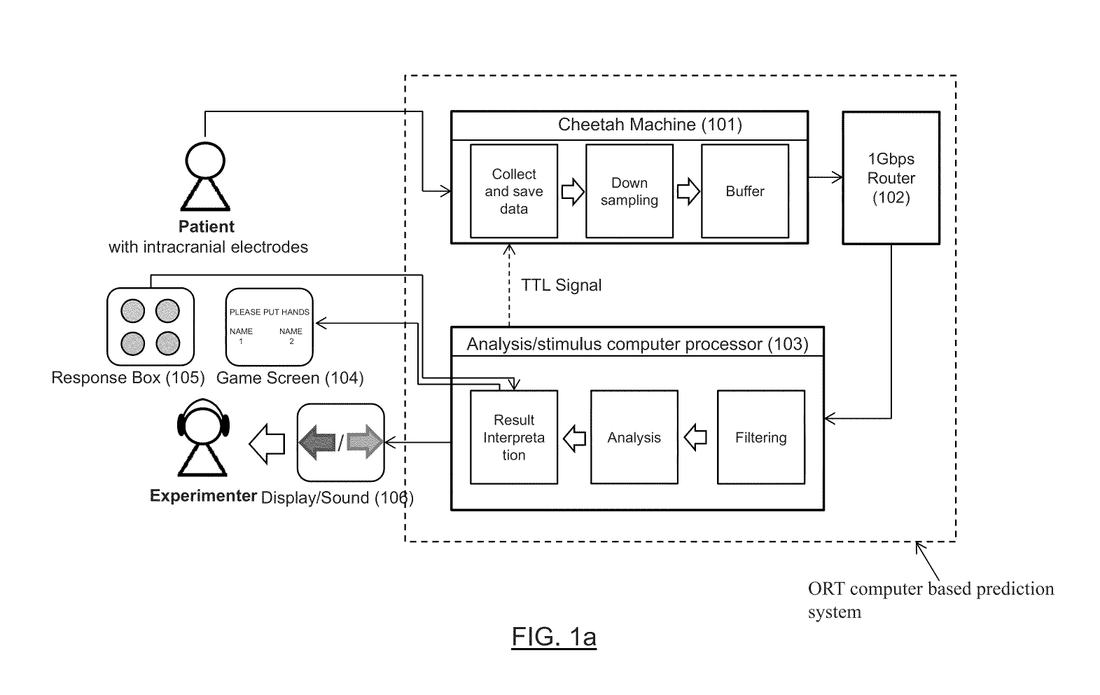

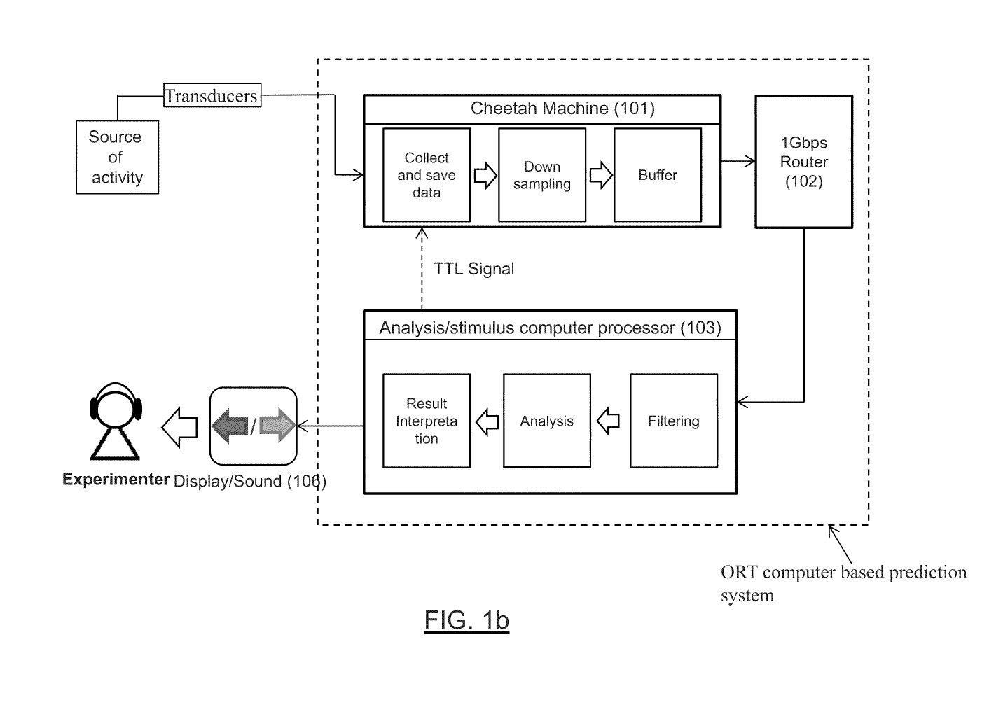

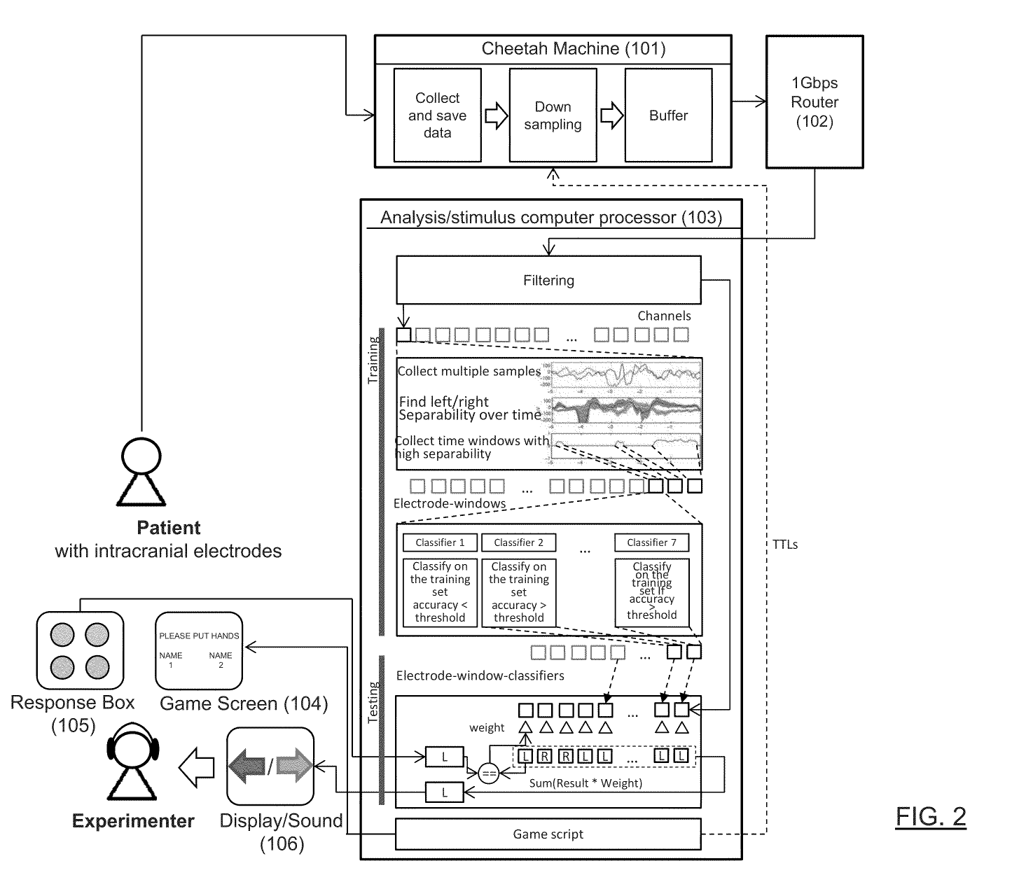

According to an exemplary embodiment of the present disclosure, FIG. 1a shows an online real-time (ORT) computer based prediction system which can predict which one of the two future actions is about to occur (for example, which one of the two hand a person would move) in a trial, with high accuracy compared to the currently available methods, up to several seconds before the person made the movement and feed the prediction back to the experimenter. A relatively high prediction performance can be achieved by using only part of the data, learning from brain activity in past trials to predict future ones, while still running the analyses quickly enough (e.g. real-time) to act upon the prediction before the subject moves. The exemplary embodiment of the (ORT) system, as shown in FIGS. 1a and 2, can rely on preparatory motor activity of a patient's brain rather than on the activity and control of motion (or imagined motion) as it occurs (e.g. observed).

Moreover, the on-line real-time (ORT) computer based prediction system can be used to understand the relation between neural correlates of decision-making and conscious, voluntary action. For example, in an experiment, as discussed in details in later sections of the present disclosure, epilepsy patients implanted with transducers, such as, intracranial depth microelectrodes or subdural grid electrodes for clinical purposes, participated in a “matching-pennies” game against either the experimenter or a computer. In each trial, subjects were given a 5 second countdown, after which they had to raise their left or right hand immediately as a “go” signal appeared on a computer screen. They won a fixed amount of money if they raised a different hand than their opponent and lost that amount otherwise. The working hypothesis of this experiment was that neural precursors of the subject's decisions precede action onset and potentially also the awareness of the decision to move, and that these signals could be detected in intracranial local field potentials (LFP) via intracranial transducers.

In accordance with the present disclosure, it can be found that low-frequency LFP signals (e.g. in the range of 0.1 Hz to 5 Hz) from a combination of plurality of channels (e.g. 10 or more channels each associated to a transducer, such as an electrode), for example, from bilateral anterior cingulate cortex, supplementary motor area, amygdala, hippocampus or orbitofrontal cortex, can be predictive of the intended movement, for example, left/right hand movements, before the onset of the go signal.

In some embodiments, each brain area in each brain hemisphere can be implanted with plurality of electrodes (e.g. 8 electrode on the left hemisphere and 8 on the right hemisphere). Each of such electrodes can be interchangeably called a channel. The plurality of channels (e.g. 10 channels) could also be from electrocorticographic signals, recorded off grids placed on the surface of the brain. These grids are usually placed over a frontotemporal cortex region of the brain, but could be placed in different places such as to cover different brain regions for different patients. The skilled person will understand that a limitation of real-time monitoring 10 channels (e.g. electrode/time window/classifiers (ETCs), as described later in the present disclosure) is a hardware limitation, which can be increased by improving the computational power and the processor speed of the analysis/stimulus computer processor (103) used in the ORT system. In some embodiments speed may also be increased by optimizing the design of the analysis software code by using methods, such as but not limited to, multi-threading and/or insertion of lower level assembly code into the analysis software code.

The exemplary embodiment of the ORT system as shown in FIGS. 1a and 2, can predict which hand a patient would raise 0.5 s before the go signal with 68±3% accuracy in more than one patient (e.g. two or more patients). Based on these results, an ORT system can be constructed that can track up to 30 or more channels simultaneously. The ORT system constructed in such way can be tested on retrospective data (e.g. data from 6 patients). Such exemplary testing can predict the correct movement choice, for example, correct hand choice, in 83% of the trials, which can rise to 92% correct if the system drops about ⅓ of the trials on which it was less confident. The exemplary embodiment of the ORT system can demonstrate the feasibility of accurately predicting a binary action in real-time for patients with intracranial recordings (e.g. intracranial transducers), well before the action occurs.

According to an exemplary embodiment of the present disclosure, FIG. 1a shows an exemplary online real-time (ORT) computer based prediction system comprising a recording system (101) (e.g. a computer based recording machine, the Cheetah machine of FIGS. 1a and 2), a router (102), an analysis/stimulus computer processor (103), a game screen (104), a response box (105), a display/sound device (106). An exemplary embodiment of FIG. 2 shows the ORT system described in FIG. 1a in more details. In some embodiments of the ORT computer based prediction system a single computer can replace the recording system (101), the router (102) and the analysis/stimulus computer processor (103).

In the exemplary ORT system, as shown in FIGS. 1a and 2, neural data from the intracranial transducers (e.g. electrodes) implanted in the subjects can be transferred to a recording system (101), which can amplify the signals from the intracranial transducers (e.g. electrodes), digitize the amplified signals to obtain digital data, down sample the digitized data (e.g. from 32 KHz to 2 KHz) and store the down sampled data into a local memory buffer in the recording system (101), for subsequent processing. In the exemplary embodiment of FIGS. 1a and 2, the recording system (e.g. Cheetah machine) can be a Digital Lynx S by Neuralynx. In some embodiments, neural data from other types of transducers can also be used in the exemplary ORT system of FIGS. 1a and 2. In accordance with the present disclosure, a transducer can be defined as a biopotential electrode which can sense ion distribution (e.g. local field potentials (LFP)) on the surface of a tissue (e.g. brain tissue), and can convert the ion current to electron current and/or that can sense local electric fields, which are dominated by electric current flowing from nearby dendritic synaptic activity within a volume of brain tissue.

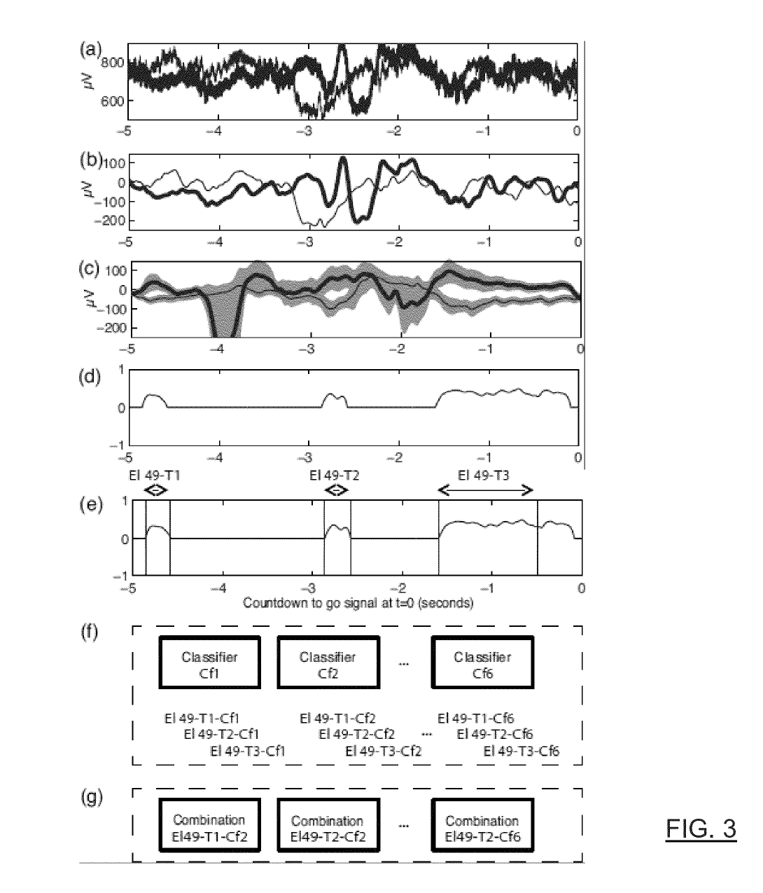

In accordance with the present disclosure, in some embodiments, the exemplary ORT system and methods (e.g. algorithm) as shown in FIGS. 1a, 1b and 2, as described in the present disclosure (and also in FIGS. 3-5, as later described), can be used to differentiate between any two types of signals (e.g. corresponding to different actions and detected via corresponding transducers) that differ in amplitude over time, where the difference over time of the amplitude can be detected via a plurality of transducers coupled to a source of the activity which engenders the different actions. Therefore, with respect to brain activity (e.g. the source of the activity is the brain of a patient), such embodiments can be used for EEG, where extracranial sensing of brain activity can be performed using electrodes placed on the scalp, or magnetoencephalography (MEG), where extracranial sensing of brain activity is performed via magnetometers placed on the head.

In some embodiments, the ORT system according to the present disclosure, can also be used to differentiate between any two type of signals that differ in amplitude over time and which are not necessarily associated with brain activity, for example, with an audio recording device to distinguish between two voices or sounds in a situation, for example, where an authority is bugging a house with various microphones and are trying to automatically know whether one of two things are about to happen (e.g., whether the speaker is about to get angry/violent or not, whether the speaker is about to lie, and so on). In latter case, the source of the activity is the house containing the speaker (or speakers) and the transducers (e.g. audio recorders) are coupled to the source by placement throughout the source (e.g. house with speaker(s)). In some other embodiments according to the present disclosure, the exemplary ORT system could be used with an array of seismic detectors, trying to predict between two types of activities, such as an earth movement larger than a certain intensity or an earth movement smaller than said intensity, and so on. In latter case, the source of the activity is the earth, and the activity can be defined by the earth movement, and the actions are defined by the movement larger or smaller than the certain intensity.

The person skilled in the art will appreciate the flexibility of the ORT system and methods of the present disclosure and will be able to use the teachings of the present disclosure to apply said ORT system, including hardware, software and associated algorithms to predict any of two actions using associated time varying signals detected by various transducers as best fit for the type of activity and associated action to be detected. Furthermore, the skilled person will understand that the present teachings can also apply to detect amongst more than two actions by iteratively classifying the more than two actions to two classes of actions, and detecting using the provided teachings one of the two classes of actions, for example, first detecting a first action from the remainder actions, then by considering the remainder actions and detecting a second action from the remainder of the remainder actions, and so on.

In the exemplary embodiments of FIGS. 1a and 2, the data stored in the memory buffer of the recording system (101) can be transferred, for example, through a dedicated network (102) (e.g. a 1 Gbps local-area network router), to the analysis/stimulus computer processor (103). The analysis/stimulus computer processor (103) can first filter the received data using a band-pass-filter to a frequency range of interest (e.g. 0.1 Hz-5 Hz range, delta and lower theta bands), using, for example, a second-order zero-lag elliptic filter with an attenuation of 40 dB. In the exemplary case where hand movements are to be predicted, it can be found that the (0.1 Hz-5 Hz) frequency range comparable to that of the readiness potential can result in optimal prediction performance. Subsequent to the filtering of the neural data, the analysis/stimulus computer processor (103) can further analyze the filtered data using various algorithms embedded within an analysis software running in the analysis/stimulus computer processor (101), identified by the analysis box in the analysis/stimulus computer processor (101) in the exemplary embodiment of FIG. 1a. These analysis algorithms are described in the later sections of the present disclosure.

The analysis/stimulus computer processor (103) can also control the game screen (104), displaying the names of the players, their current scores and various instructions. The analysis/stimulus computer processor (103) can further control the response box (105), which consists of an input/output device (e.g. 4 LED-lit buttons). The buttons of the subject and his/her opponent can flash red or blue whenever he/she or his/her opponent wins, respectively. Additionally, the stimulus/analysis computer processor (103) can send an unique transistor-transistor logic (TTL) pulse from a game script (as shown in FIG. 2) located inside the stimulus/analysis computer processor (103), whenever the game screen (104) changes or a button is pressed on the response box (105), which can synchronize the timing of these events with the LFP recordings. In real-time game sessions the analysis/stimulus computer processor (103) can also display the appropriate arrow on the computer screen behind the subject and can play a monophonic tone, indicating the predicted hand movement in the appropriate earphone of the experimenter sometime before, for example, 0.5 s before go-signal onset as shown in the exemplary embodiment of FIGS. 1a and 2.

The analysis software used in the analysis/stimulus computer processor (103), as shown in the exemplary embodiment of the ORT system of FIGS. 1a and 2, can comprise a machine-learning algorithm that can train on past-trials data to predict the current trial. The initial training can be done on the first 70% of the past trials, with the prediction carried out on the remaining 30% using the trained parameters together with an online weighting system. In such case, it can be assumed that the system can examine only neural activity, and cannot have any access to the subject's left/right-choice history (e.g. behavioral-history data). In some embodiment, the machine learning algorithm can be designed to analyze data from several brain channels (e.g. each associated to a transducer), up to 64 brain channels, one channel at a time. However, a person skilled in the art would recognize that the number of brain channels are not limited to 64, and can be increased or decreased if desired.

According to an exemplary embodiment of the present disclosure, FIG. 3 shows the training phase of the ORT system of FIGS. 1a and 2. After filtering all the sample data (e.g. neural data) obtained through all the training trials as shown in FIGS. 3a-b, the ORT system can further analyze these sample data and calculate the mean and standard error over all leftward and rightward training trials, separately, as shown in FIG. 3c. The ORT system, through the analysis software, can then use the mean and standard error over all leftward and rightward training trials to determine the time windows with high separability, as shown in the exemplary FIG. 3d, and 3e, and train the classifiers on data corresponding to these time windows as shown in exemplary FIGS. 3f-g. Throughout the present disclosure, the data collected within time windows with high separability can be referred to as electrode windows (FIG. 2), and will be used in the subsequent prediction process.

After determining the time windows for each channel, the ORT system through its analysis software can feed the electrode windows of each channel to all the classifiers for a subsequent internal cross validation procedure (as shown in FIG. 2). Cross validation can be defined as a statistical technique that can be used for predictive statistical models, i.e. when one wants to test to what degree a model that was trained on a given data set will generalize to new data. For example, from a data set the first 70% of the neural data before any movements, for example, left/right movement, with the answer for each trial whether a patient from whom the data has been collected ended up moving left of right can be selected, and the given system can be trained based on that data. Once trained, the system can start to receive neural data from new and never before seen trials, for which the direction the patient will move, for example, left or right is unknown. Therefore, the first 70% of the data can be the training set and the last 30% can be the test set.

In some embodiments, the system can have abundance of information and only a few data samples (for example, around 50 trials). For example, the exemplary system used to generate the results of FIGS. 3a-2g, 6, 8 and 9, have approximately 5 s of data per channel at 2 KHz sampling rate, and 64 channels of data, which is more than 600,000 data points. Therefore, even when considering certain channels with high separability, the system may need to consider tens of thousands of data points, and in such case, the system can be trained on these tens of thousands of data points using a few tens of trials in the training set. Therefore, one can be motivated to train a system that would work very well on the training set. However, such model system cannot be used in other data because it is specifically constructed to fit the training data set, and may not generalize well to new data, which can be called the overfitting problem.

For example, a linear regression over 11 data points on a plane can be considered. It can be assumed that the data points are more or less on a 45 degree line passing through the origin. Therefore, the true model can be written as y=x, which can be noisy and the corresponding data can be (1, 1.1), (2, 1.93), (3, 2.87) . . . (11, 11.07). If such data is used to fit in, for example, a 10th order polynomial, it can fit perfectly to the data and the subsequent training error can be 0. However, if this 11th-order polynomial is generalize to a new point, for example, at x=12, a large error can occur which can be further increased with x=20 . . . x=100. Therefore, in such cases, simple models or systems can be more accurate and useful than overly complex models. The validity of a system model on the training set can be verified using internal cross-validation.

For example, if there are 40 data samples, the first 70% of the data (i.e. 28 samples) can be used as a training set. Therefore, training the system only on 28 samples from 40 samples, without exposing it to the remaining 12 samples. The system can then be tested on the remaining 12 samples. In the regression example above, this could be compared to training the system on x=1 to 8 and then testing the results on x=9, 10 and 11. In the next step, the results of the system can be compared to the actual results, assuming the actual movement data for the entire training set is available. In such way, if system's answers for x=9, 10 and 11 are significantly different from the actual results, one can conclude that the system parameters should be changed. In some embodiments, the system may not be trained on the first 80% of the data as training and the rest as test, but rather cutting the data a few times into 80% training and 20% testing, and then verifying how well the system predicted on those 20% testing-sets. The advantage of this internal cross-validation procedure can be that as long as the statistical properties of the data are similar enough between the training set and the never-before-seen test set, internal cross-validation on the training set will tend to lead to relatively good generalization on the test set.

In the exemplary ORT system as shown in the exemplary embodiment of FIGS. 1a and 2, each classifier can be defined to register a certain feature of the signal. In the exemplary ORT system, as shown in the exemplary embodiment of FIG. 2, each of the 7 classifiers can be tested on each electrode window with high-enough separability. This can result in tens or even hundreds of tested electrode/time window/classifiers (ETCs) combinations. In the next step, internal cross-validation can be applied on the results with the best combinations. For example, and depending on the processing power of the analysis/stimulus computer processor (102), best 10 or another number of ETC combinations can be selected when working in real-time. On the other hand, while working offline, every combination with accuracy above a certain level, for example, combinations with accuracy≧68%, can be selected. The internal cross validation procedure can be performed on the training or available data from the previous predictions to understand, how well the classifiers can classify the training data. For example, as described above, the initial training can be done on the first 70% of the trials, with the prediction carried out on the remaining 30% using the trained parameters. It should be noted that throughout the present disclosure and figures, the terms ETC and CTC (channel/time window/classifier) are used interchangeably.

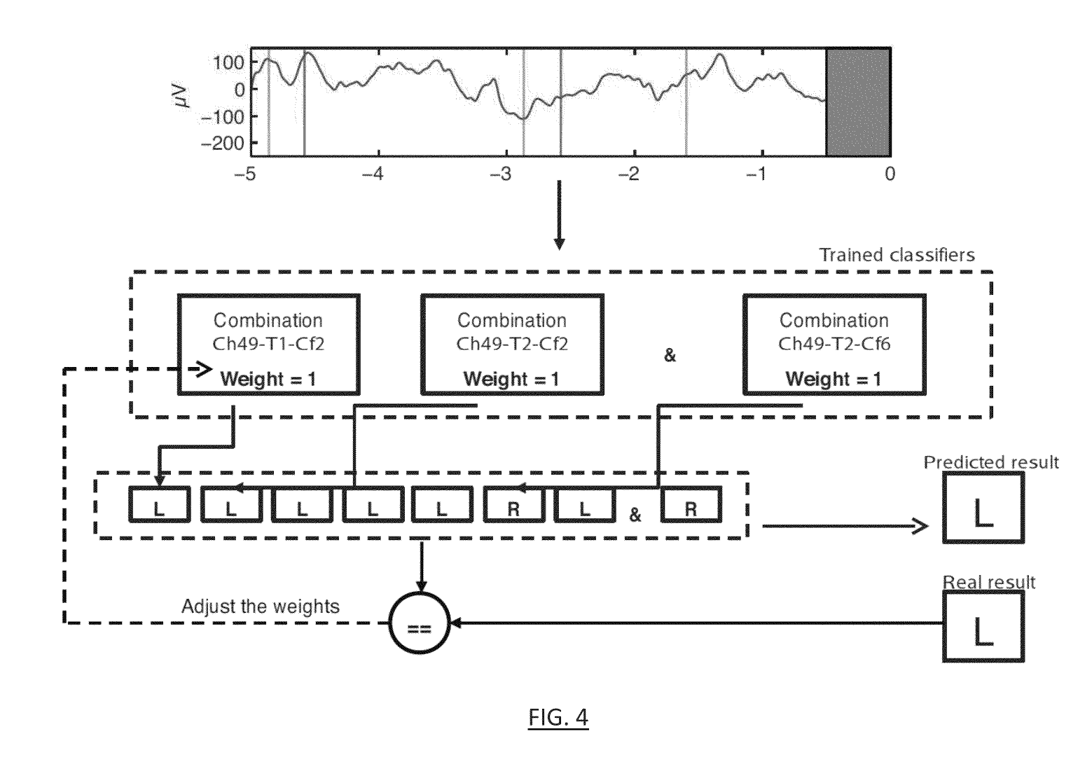

Based on the results of the internal cross validation, the best electrode/time-windows/classifiers (ETC) combinations can be used to predict the current trial in the prediction phase, as shown in the exemplary embodiment of FIG. 4, which is discussed in the later sections of the present disclosure. In the exemplary embodiment of FIG. 4, the number of ETCs that can be actively monitored is limited to 10 considering the computational power of the real-time system which is used for the computation. However, a person skilled in the art will understand that this limitation of monitoring 10 ETCs is a hardware limitation which can be increased by improving the computational power and the processor speed of the analysis/stimulus computer processor (103) used in the ORT system. In some embodiments speed may also be increased by optimizing the analysis software code by using methods, such as, multi trading and/or insertion of lower level assembly code.

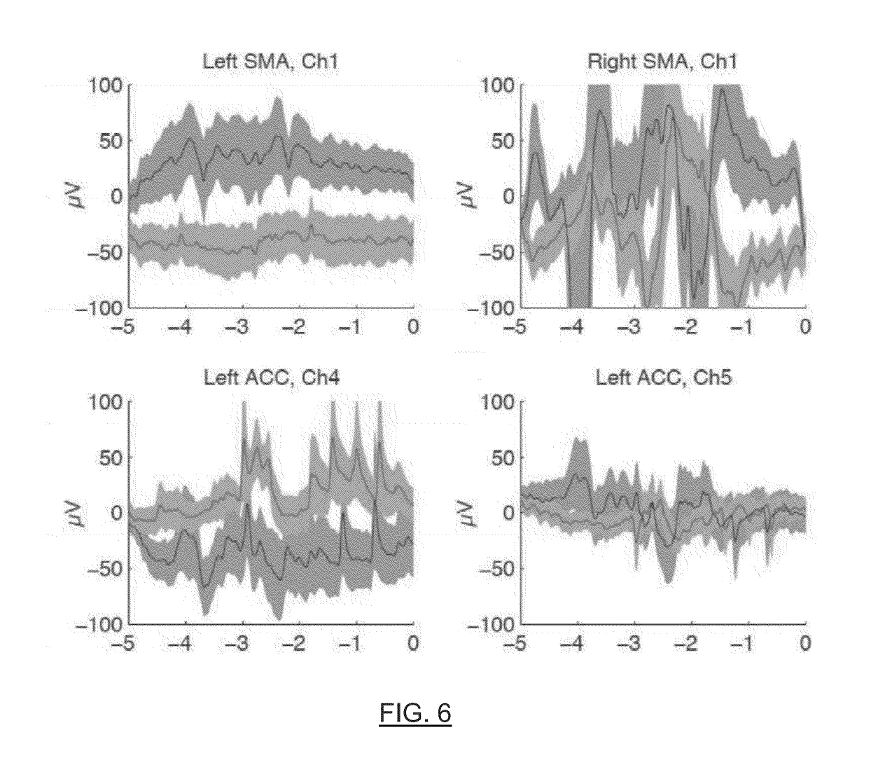

The exemplary analysis software can be designed to find the time windows or the electrode windows with the best left/right separation for the different recording channels over the training set as shown in FIGS. 3c-e (also in FIG. 6, described in details in later sections). Moreover, the an algorithm within the analysis software, namely a prediction algorithm, can be designed to predict whether the signal a_{N}(t) on trial N will result in a leftward or rightward movement. In other words, such an algorithm can be designed to predict whether the label of the N^{th} trial will be leftward (Lt) or rightward (Rt), respectively. In this case, for each recording channel, the algorithm can look at the N−1 previous trials a₁(t), a₂(t), a_{N-1}(t), and their associated labels as l₁, l₂, . . . , l_{N-1}.

Now, it can be assumed that the leftward movement as a function of t can be written as L(t)={aᵢ(t)|lᵢ=Lt}ᵢ₌₁^{N-1} and rightward movement as a function of t can be written as: R(t)={aᵢ(t)|lᵢ=Rt}ᵢ₌₁^{N-1} be the set of previous leftward and rightward trials in the training set, respectively. Furthermore, it can also be assumed that Lₘ(t) (Rₘ(t)) and Lₛ(t) (Rₛ(t)) are the mean and standard error of L(t) (R(t)), respectively. Therefore, the normalized relative left/right separation function at time t, δ(t), (see the exemplary FIG. 3d) can be defined as:

$$δ ( t ) = \{ \begin{matrix}\frac{\begin{matrix}[ {L}_{m} ( t ) - {L}_{s} ( t ) ] - \\ [ {R}_{m} ( t ) + {R}_{s} ( t ) ]\end{matrix}}{{L}_{m} ( t ) - {R}_{m} ( t )} & \begin{matrix}if [ {L}_{m} ( t ) - {L}_{s} ( t ) ] - \\ [ {R}_{m} ( t ) + {R}_{s} ( t ) ] > 0\end{matrix} \\ - \frac{\begin{matrix}[ {R}_{m} ( t ) - {L}_{s} ( t ) ] - \\ [ {R}_{m} ( t ) + {R}_{s} ( t ) ]\end{matrix}}{{L}_{m} ( t ) - {R}_{m} ( t )} & \begin{matrix}if [ {L}_{m} ( t ) - {L}_{s} ( t ) ] - \\ [ {R}_{m} ( t ) + {R}_{s} ( t ) ] > 0\end{matrix} \\ 0 & Otherwise\end{matrix} \qquad Eq . ( 1 )$$

Thus, from the above equation (1), δ(t)>0 (δ(t)<0) means that the leftward trials can tend to be considerably higher (or lower) than rightward trials for that channel at time t, while δ(t)=0 suggests no left/right separation at time t. In such case, a consecutive time period of δ(t)>0 or δ(t)<0 for t<prediction time (i.e., the time before the go signal when it is desired for the system to output a prediction, for example, −0.5 s for the ORT trials) can be defined as a time window as shown in the exemplary FIG. 3e. After all time windows are found for all channels, in the next step of the algorithm, time windows less than M ms apart can be combined into one. Then, for each time window from t₁ to t₂ it can be defined that a=fₜ_{₁}^{₂}|δ(t)|dt. Therefore, all time windows satisfying a<A can be eliminated. In the exemplary ORT system, as shown in the exemplary embodiment of FIGS. 1a and 2, it can be found that the values M=200 ms and A=4,500 μVms can be optimal for real-time analysis of the hand movement prediction. These results can be found, for example, in 20-30 electrode windows over all channels, for example, over 64 channels that have been monitored during the experiment. In such case, with the go-signal onset at t=0, all time windows can be between −5 s and the desired prediction time, as shown in exemplary embodiment of FIG. 4.

In the exemplary ORT system, as shown in the exemplary embodiment of FIGS. 1a and 2, ensemble learning with seven types of binary classifiers (due to real-time processing considerations) on every channel's time windows can be used as shown in the exemplary FIG. 3f. In this case, among the seven types of binary classifiers, five of the classifiers can be shape-based, testing whether the signal to be predicted is more similar to the mean measure of the previous signals (for example, left versus right hand movement signal), with the measures being the (1) median, (2) mean, (3) overall L1 norm, (4) overall L2 norm, or (5) overall convexity or concavity. The other two classifiers among the seven types of binary classifiers can be (6) linear support-vector machine, and (7) k-nearest neighbors with Euclidean distance. In such case, each classifier can be optimized for certain types of features. To estimate the generalizable accuracy of each classifier, the exemplary ORT system can be trained and tested by using, for example, a 70/30 cross-validation procedure within the training set. In the exemplary ORT system of the present disclosure, each classifier can be tested on every time windows of every channel, discarding those, for example, with accuracy<0.68. In such case, the training phase can ultimately output a set of S binary ETC combinations (for example, the binary ETC combinations with accuracy more than desired) as shown in the exemplary FIG. 3g that can be used in the prediction phase as shown in the exemplary embodiment of FIGS. 2 and 4.

In the prediction phase (e.g. using the prediction algorithm) each of the overall S binary ETCs can calculate a prediction, ciε{−1,1} (for example, for right and left, respectively) independently at the desired prediction time. It this phase, all classifiers can be initially given the same weight, w₁=w₂= . . . =wₛ=1. The prediction algorithm can then calculate ξ=Σᵢ₌₁^{S}wᵢcᵢ and can predict a movement, for example, left (or right) if ξ>d (or ξ<−d), or declare it an undetermined trial if −d<ξ<. In such case, d can be the drop-off threshold for the prediction. Thus, the larger d is, the more confident the system can be to make a prediction, and the larger the proportion of trials on which the system abstains the drop-off rate. In such case, the weight wᵢ can be associated with ETCᵢ and can be increased (or decreased) by, for example, by 0.1 whenever ETCᵢ predicts the movement (for example, hand movement) correctly (or incorrectly). A constantly erring ETC can therefore become increasingly small and then increasingly negative.

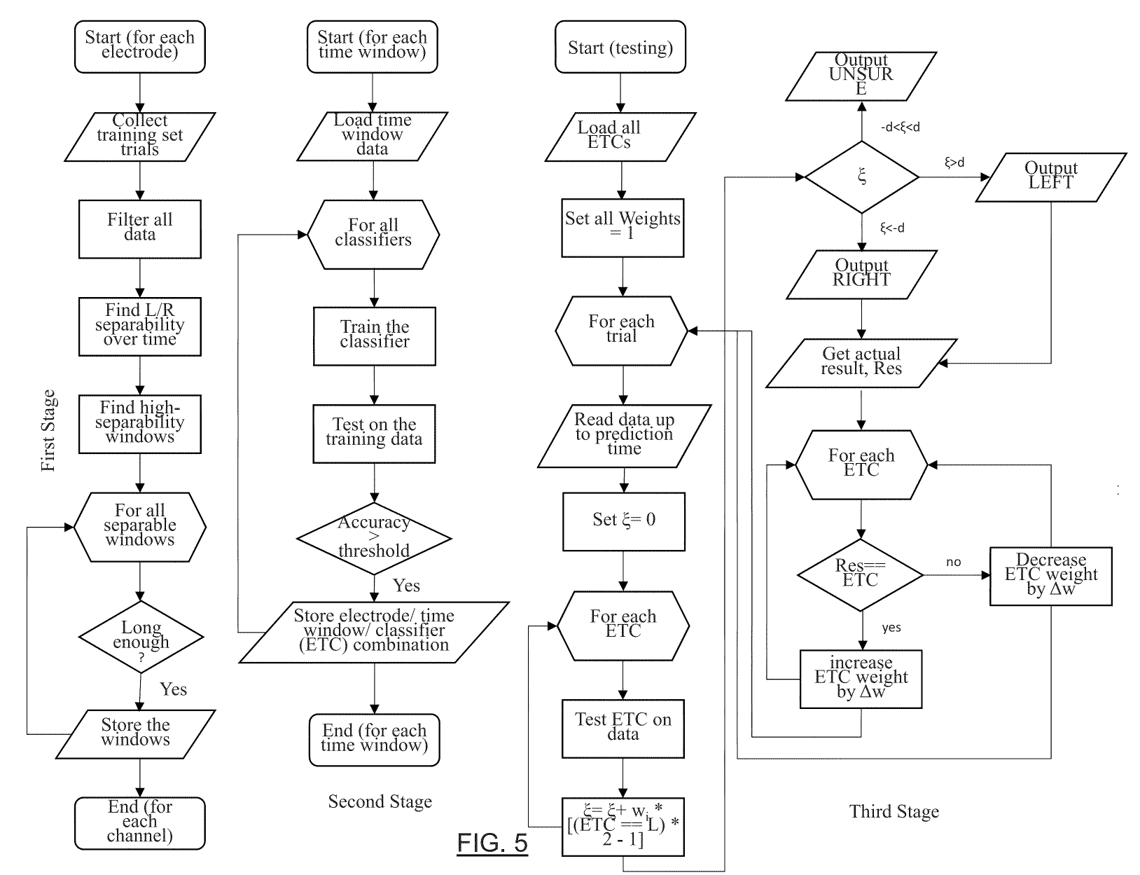

According to an exemplary embodiment of the present disclosure, FIG. 5 shows the prediction algorithm used in the ORT system to predict a movement, for example, a left/right hand movement. The first stage of the algorithm, which determines the time windows with high separability, starts with i) processing data from each electrode. As shown in FIG. 5, in the subsequent steps, the algorithm can ii) collect training set trials, iii) filter all the data, iv) determine left/right seperability over time, v) determine the time windows with high separability, vi) for all separable time windows: vii) calculate if the time windows are longer than a desirable threshold and viii) store the electrode windows above such threshold and repeat the steps (vi) to (viii) of the first stage of the algorithm, until all the time windows above the desirable threshold length is stored.

The second stage of the algorithm which determines the electrode/time window/classifier (ETC) combination by training and testing the various classifiers, as shown in the exemplary embodiment of FIG. 5, starts with i) processing data from each time window. As shown in FIG. 5, in the next step, the algorithm can ii) load the time window data. In the subsequent steps, iii) for all classifiers: the algorithm can iv) train the classifier, v) test the classifier on the training data, vi) calculate the accuracy of a classifier and determine if the accuracy of a classifier is greater than a desirable threshold and vii) store the electrode/time windows/classifier (ETC) combination above such threshold and repeat the steps (iii) to (vii) of the second stage of the algorithm, until all the electrode/time windows/classifier combination above the desirable accuracy is stored.

The third stage of the algorithm, which is used to generate a output to predict a movement, using the ETCs combinations from the second stage of the algorithm, as shown in the exemplary embodiment of FIG. 5, starts with i) processing the electrode/time window/classifier (ETC) data for testing. As shown in FIG. 5, in the next steps, the algorithm can ii) load all ETCs, iii) set all weights to 1. In the subsequent steps iv) for each trial, the algorithm can v) read data up to prediction time, vi) set result ξ=0, vii) for each ETC viii) test ETC on data and ix) calculate result, where ξ=ξ+wᵢ*[(ETC==L)*2−1]. Steps (vii) to (ix) of the third stage of the algorithm can be repeated until results for each ETC are calculated. In the next step of the algorithm, the algorithm can compare x) if the result ξ is greater than a specific value d (ξ>d), less than a specific value (−d) (i.e. ξ<−d), or (−d≦ξ≦d). In case the (ξ>d), the algorithm can xi) output right, xii) in case (ξ<−d), the algorithm can output left, and xiii) in case (−d<ξ<d), the algorithm can output unsure. In the next step of the algorithm, the algorithm can determine xiv) actual results (Res) and xv) for each ETC, xvi) the algorithm can compare (Res) with ETC, (i.e. Res==ETC). If the result from step (xvi) is yes, the algorithm can xvii) increase ETC weight by Δw and the algorithm can repeat from step (iv) or step (xiv) of the third stage of the algorithm. If the result from step (xvi) is no, the algorithm can xviii) decrease ETC weight by Δw and the algorithm can repeat from step (iv) or step (xiv) of the third stage of the algorithm.

In accordance with an exemplary embodiment of the present disclosure, the various functions of the analysis/stimulus computer processor, as described in previous paragraphs and shown in FIGS. 1a and 2, used in the ORT system can be implemented in MATLAB 2011a (Math Works, Natick, Mass.) as well as in C++ on Visual Studios 2008 (Microsoft, Redmond, Wash.) for enhanced performance. The brain signals or the neural data from the intracranial electrodes can be collected by Digital Lynx S system using Cheetah 5.4.0 (Neuralynx, Redmond, Wash.). In some embodiment the functionalities of the Digital Lynx S system using Cheetah 5.4.0 can be combined with analysis/stimulus computer processor. In some other exemplary embodiments, a simulated-ORT system can also be implemented in MATLAB 2011a. The exemplary simulated-ORT analysis carried out in this paper can use real patient data saved on the Digital Lynx system. However, a person skilled in the art would understand that the implementation of the above mentioned ORT system is not limited to the above mentioned software or the computer processors and can be implemented with other suitable software and processing systems.

In the exemplary ORT system, as described in the exemplary embodiment of FIGS. 1a and 2, the neural data from the intracranial electrodes for the simulated results and predictions using the algorithm as described above, have been collected from seven subjects who were consenting intractable epilepsy patients that were implanted with intracranial electrodes as part of their pre-surgical clinical evaluation (between ages 18-60, 3 males). However, a person skilled in the art would understand that the prediction algorithm used in the exemplary simulated ORT system can be successfully implemented on neural data from the intracranial electrodes collected from other sources, for example, other humans, software, etc.

The subjects were inpatients in the neuro-telemetry ward at the Cedars Sinai Medical Center or the Huntington Memorial Hospital, and are designated with CS or HMH after their patient numbers, respectively. Five of them, P12CS, P15CS and P29-31HMH were implanted with intracortical depth electrodes targeting their bilateral anterior-cingulated cortex, amygdala, hippocampus and orbitofrontal cortex. These electrodes had eight 40 μm micro-wires at their tips, 7 for recording and 1 serving as a local ground. One patient, P15CS, had additional micro-wires in the supplementary motor area. The LFP recorded from the micro-wires have been in this study. Two other patients, P16CS and P19CS, were implanted with an 8×8 subdural grid (64 electrodes) over parts of their temporal and prefrontal dorsolateral cortices. The data of one patient, P31HMH was excluded because micro-wire signals were too noisy for meaningful analysis. The institutional review boards of Cedars Sinai Medical Center, the Huntington Memorial Hospital and the California Institute of Technology approved the experiments.

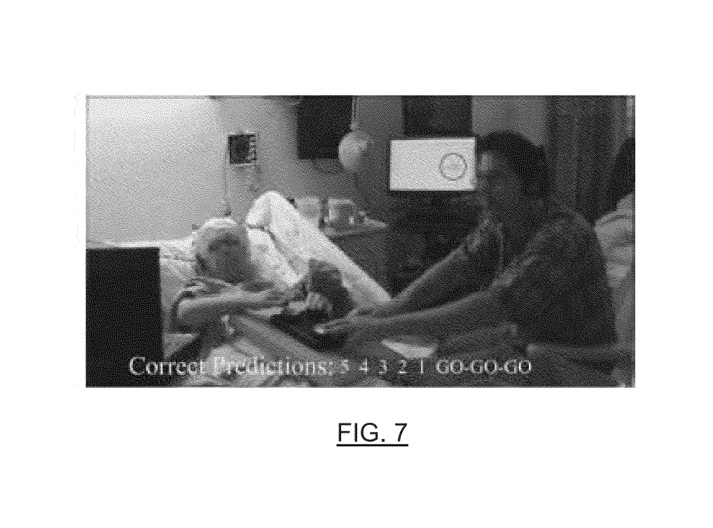

During the experiment, the subject sat in a hospital bed in a semi-inclined “lounge chair” position. The stimulus/analysis computer, as shown in black at the bottom left of the exemplary FIG. 7, displaying the game screen was positioned to be easily viewable for the subject. When playing against the experimenter, the latter sat beside the bed. The response box was placed within easy reach of the subject as also shown in the exemplary FIG. 7.

As part of this experiment's focus on purposeful, reasoned action, the subjects did play a matching-pennies game, i.e. a 2-choice version of “rock paper scissors”, either against the experimenter or against a computer. The subjects pressed down a button with their left hand and another with their right on a response box. Then, in each trial, there was a 5 s countdown followed by a go signal, after which they had to immediately lift one of their hands. It was agreed beforehand that the patient would win the trial if he/she lifted a different hand than his/her opponent, and lose if he/she raised the same hand as her opponent. Both players started off with a fixed amount of money, $5, and in each trial $0.10 was deducted from the loser and awarded to the winner. If a player did not lift her hand within 500 ms of the go signal, or lifted no hand or both hands, that could result in an error trial and he/she lost $0.10 cents without his/her opponent gaining any money. The subjects were shown the countdown, the go signal, the overall score, and various instructions on a stimulus computer placed before them. Each game consisted of 50 trials. If, at the end of the game, the subject had more money than her opponent, he/she received that money in cash from the experimenter.

Before the experimental session began, the experimenter explained the rules of the game to the subject, and the subject could practice playing the game until he/she was familiar with it. Consequently, patients usually made only few errors during the games (<6% of the trials). Following the tutorial, the subject played 1-3 games against the computer and then once against the experimenter, depending on their availability and clinical circumstances. The two first games of P12CS were removed because the subject tended to constantly raise the right hand regardless of winning or losing.

In the above experiment, two patients, P15CS and P19CS, were tested in actual ORT conditions. In such sessions, 3 games for P15CS and 3 for P19CS, the subjects always played against the experimenter. These ORT games were different from the other games in two respects. First, a computer screen was placed behind the patient, in a location where he/she could not see it. Second, the experimenter was wearing earphones as shown in FIGS. 1a, 2 and 7. Half a second before go-signal onset, an arrow pointing towards the hand that the system predicted the experimenter had to rise to win the trial, was displayed on that screen. Similarly, a monophonic tone was played in the experimenter's earphone ipsilateral to that hand. The experimenter then lifted that hand at the go signal.

In the experiment as described above, the patients, who were implanted with intracranial electrodes for clinical purposes, participated in a matching-pennies game against the experimenter or a computer. In each trial, a 5 s countdown was followed by a go signal, at which the subjects had to raise their left or right hand immediately. They won a fixed amount of money if they raised a different hand than their opponent and lost the same amount otherwise.

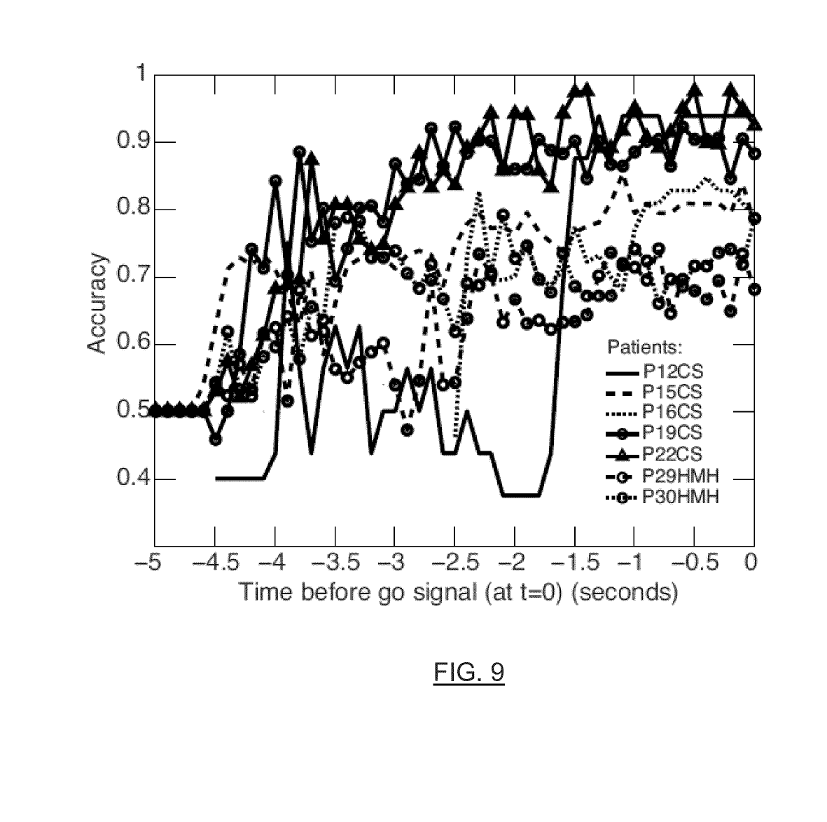

The exemplary ORT prediction system was tested using the data from the experiment, as described above, in actual real-time on 2 patients, P15CS and P19CS (a depth and grid patient, respectively), with a prediction time of 0.5 s before the go signal. In this experiment, because of computational limitations, the system could only track 10 channels with one ETC per channel in real-time. For P15CS, an accuracy of 72±2% (i.e. ±standard error; p=10−8, binomial test; accuracy=number of accurately predicted trials/(total number of trials−number of dropped trials)) was achieved without modifying the weights online during the prediction. For P19CS the ORT system wasn't given patient specific training. In that case, average parameter values over previous patients were used instead. In such case, the prediction accuracy was significantly above chance 63±2% (i.e. ±standard error; p=7·10−4, binomial test). As far as the results of grid and depth patients can be compared as shown in exemplary FIG. 9, this can suggest that patient-specific training may add around 9% to the ORT prediction accuracy.

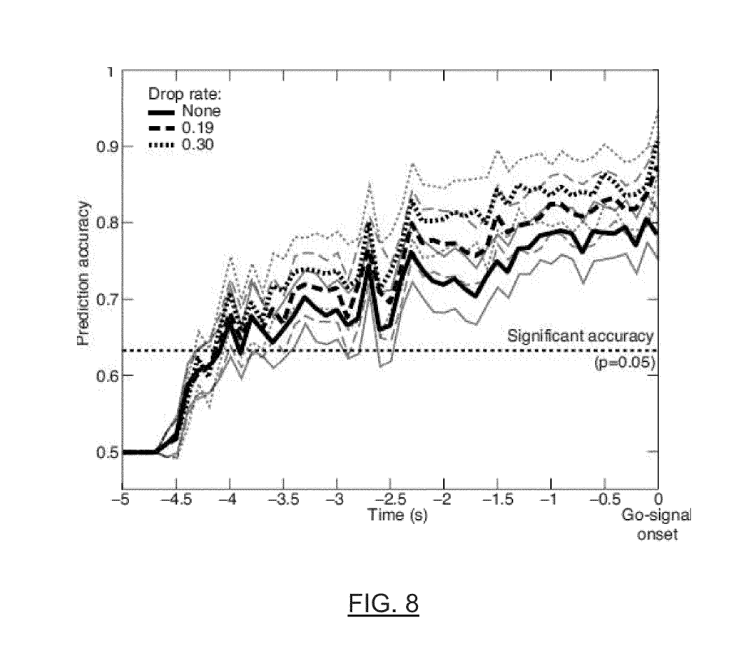

To understand how accuracy can be improved with optimized hardware/software, in the above experiment, the simulated-ORT was operated at various prediction times between 5 s before the go signal and the go signal. 3 drop-off thresholds, for example, 0, 0.1 and 0.2 were further tested for the ORT system, which resulted in 3 drop-off rates (for example, drop-off rate=number of dropped trials/total number of trials). However, in the above experiment, while running offline, 20-30 ETCs were tracked, which resulted in considerably higher accuracies as shown in FIGS. 8 and 9. Averaged over all subjects, in the experiment as described above, the accuracy rose from about 65% more than 4 s before the go signal to 83-92% close to go-signal onset, depending on the allowed drop-off rate. In particular, it was observed that for a prediction time of 0.5 s before go signal onset, the experimenter could achieve accuracies of 81±5% and 90±3% (±standard error) for P15CS and P19CS, respectively, with no drop-off as shown in the exemplary FIG. 9.

In accordance with the present disclosure, the exemplary ORT system based on intracranial recordings, as shown in exemplary embodiment of FIGS. 1a and 2, can predict which specific hand a person would raise well before movement onset at accuracies much greater than chance in a competitive environment. The system was further tested off-line, which can suggest that with optimized hardware/software such action contents would be predictable in real-time at relatively high accuracies already several seconds before movement onset. In the experiment, both the prediction accuracy and drop-off rates close to movement onset are much superior to those achieved before movement onset with non-invasive methods like EEG and fMRI [see, for example, references 7 and 12-14, incorporated herein as reference in their entirety].

As discussed in the previous sections, in the experiment the subjects played a matching pennies game to keep their task realistic, so that it would mimic real-life situations like rock-scissors-paper games [see, for example, reference 15, incorporated herein by reference in its entirety]. In the experiment, a Libet-type clock that would have required subjects to report when they had made their decision to move [see, for example, reference 1, incorporated herein by reference in its entirety] was not included, since such a clock can be inaccurate and may moreover introduce artifacts into the experiment. For example, there may be systematic biases in the time read off an analogue or digital clocks [see, for example, references 16 and 17, incorporated herein by reference in their entirety], and the position of the clock may be backward-inferred rather than actually perceived [see, for example, references 18 and 19, incorporated herein by reference in their entirety]. Moreover, this clock at best can measure the onset of the ability to report when a decision has been made, rather than the potentially earlier onset of the decision itself [see for example, reference 20, incorporated herein by reference in its entirety]. It has also been demonstrated that the presence of the clock may affect motor-preparatory as well as motor neural signals and their timing [see, for example, references 21-23, incorporated herein by reference in their entirety].

After completion of the experiment, the subjects were interviewed and asked when along the 5s countdown they sensed that they had made up their mind. The subjects who participated in the experiment reported that they decided late, close to the go signal, and were often still deliberating at the onset of the go signal. Their actions, in contrast, were generally predictable above chance already 4 s or more before go-signal onset as shown in the exemplary FIG. 8. Under the assumption that the subjects' reports about their late conscious decision times were accurate, the results from the experiment can be compatible with their action contents having been predictable online and in real-time before they became aware of having made up their mind. Moreover, a reasonable interpretation of an abrupt rise in prediction accuracy at a certain time is that it corresponds to a (for example, potentially unconscious) decision having been made at that time. Therefore, if the subjects' reports of having consciously decided late are trusted once more, the abrupt rises in single-subject prediction accuracies that then tend to plateau well before the onset of the go signal as shown in the exemplary FIG. 9, can be compatible with the subjects' decisions having been ORT-predictable before they became aware of them.

Accurate real-time prediction before movement onset can be useful to investigating the relation between the neural correlates of decisions, their awareness, and voluntary action [see for example, references 24 and 25, incorporated herein by reference in their entirety]. The ability to predict action contents before action onset accurately online and in real-time can facilitate many types of experiments that were not feasible before in the neuro-scientific study of decision-making, agency and volition. For example, it would make it possible to study decision reversals on a single-trial basis, or to test whether subjects can guess above chance which of their action contents are predictable from their current brain activity, potentially before having consciously made up their mind [see, for example, references 24 and 26, incorporated herein by reference in their entirety]. Accurate decoding these preparatory motor signals may also result in earlier and improved classification for brain-computer interfaces.

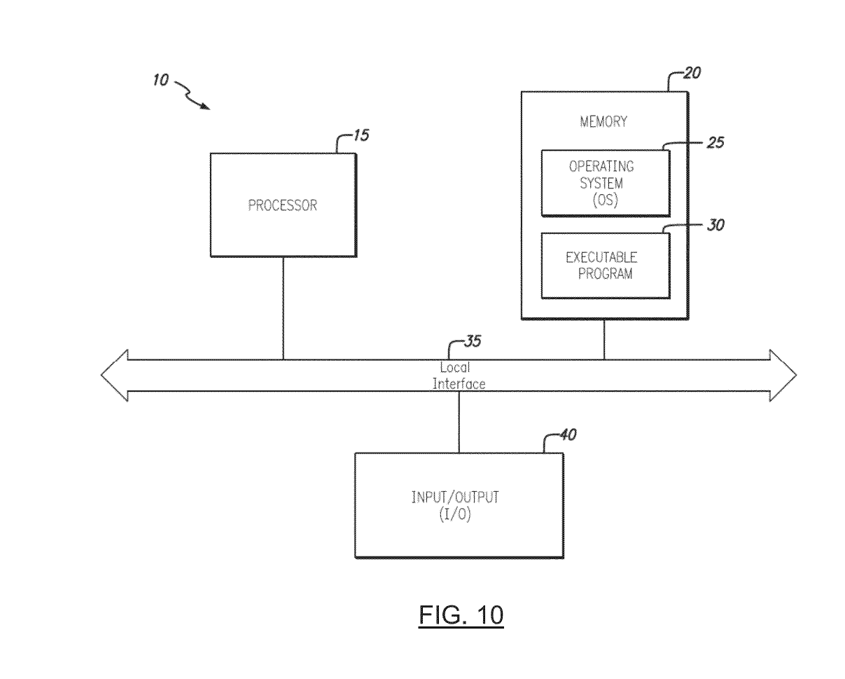

The analysis/stimulus computer processor (103) which includes the analysis software (e.g. filtering, analysis and result interpretation), as shown in the exemplary embodiment of the ORT system of FIGS. 1a, 1b and 2, can be implemented using any target hardware (e.g. FIG. 10) with reasonable computing power and memory, either off the shelf, such as a mainframe, a microcomputer, a desktop (PC, MAC, etc.), a laptop, a notebook, etc., or a proprietary hardware designed for the specific task and which may include a microprocessor, a digital signal processor (DSP), various FPGA/CPLD, etc. For any given hardware implementation of the analysis/stimulus computer processor (103), corresponding software/firmware may be used to generate some features (e.g. algorithms) of the analysis software (e.g. filtering, analysis and result interpretation), used in the ORT system to predict a movement, and some features (e.g. filtering using combination dedicated hardware/firmware) can be generated using the target hardware.

FIG. 10 shows an exemplary embodiment of a target hardware (10) (e.g. a computer system) for implementing the embodiment of the analysis/stimulus computer processor (103) and the associated analysis software (e.g. filtering, analysis and result interpretation), as shown in the exemplary embodiment of the ORT system of FIGS. 1a, 1b and 2. This target hardware comprises a processor (15), a memory bank (20), a local interface bus (35) and one or more input/output devices (40). The processor may execute one or more instructions related to the execution of the analysis software (e.g. filtering, analysis and result interpretation) and as provided by the operating system (25) based on some corresponding executable program stored in the memory (20). These instructions are carried to the processors (20) via the local interface (35) and as dictated by some data interface protocol specific to the local interface and the processor (15). It should be noted that the local interface (35) is a symbolic representation of several elements such as controllers, buffers (caches), drivers, repeaters and receivers that are generally directed at providing address, control, and/or data connections between multiple elements of a processor based system. In some embodiments the processor (15) may be fitted with some local memory (cache) where it can store some of the instructions to be performed for some added execution speed. Execution of the instructions by the processor may require usage of some input/output device (40), such as inputting data from a file stored on a hard disk, inputting commands from a keyboard, outputting data to a display, or outputting data to a USB flash drive.

In some embodiments, the operating system (25) facilitates these tasks by being the central element to gathering the various data and instructions required for the execution of the program and provide these to the microprocessor. In some embodiments the operating system may not exist, and all the tasks are under direct control of the processor (15), although the basic architecture of the target hardware device (10) will remain the same as depicted in FIG. 10. In some embodiments a plurality of processors may be used in a parallel configuration for added execution speed. In such a case, the executable program may be specifically tailored to a parallel execution. Also, in some embodiments the processor (15) may execute part of the implementation of the analysis/stimulus computer processor (103) and the associated analysis software (e.g. filtering, analysis and result interpretation), as shown in the exemplary embodiment of the ORT system of FIGS. 1a, 1b and 2, and some other part may be implemented using dedicated hardware/firmware placed at an input/output location accessible by the target hardware (10) via local interface (35). The target hardware (10) may include a plurality of executable program (30), wherein each may run independently or in combination with one another.

All patents and publications mentioned in the specification may be indicative of the levels of skill of those skilled in the art to which the disclosure pertains. All references cited in this disclosure are incorporated by reference to the same extent as if each reference had been incorporated by reference in its entirety individually.

The examples set forth above are provided to give those of ordinary skill in the art a complete disclosure and description of how to make and use the embodiment of online real-time (ORT) computer based prediction system of the disclosure, and are not intended to limit the scope of what the inventors regard as their disclosure. Modifications of the above-described modes for carrying out the disclosure may be used by persons of skill in the art, and are intended to be within the scope of the following claims.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a”, “an”, and “the” include plural referents unless the content clearly dictates otherwise. Unless defined otherwise, all technical and scientific terms used herein have the same meaning as commonly understood by one of ordinary skill in the art to which the disclosure pertains.

A number of embodiments of the disclosure have been described. Nevertheless, it will be understood that various modifications may be made without departing from the spirit and scope of the present disclosure. Accordingly, other embodiments are within the scope of the following claims.

### REFERENCES

[1] B. Libet, C. Gleason, E. Wright, and D. Pearl, “Time of conscious intention to act in relation to onset of cerebral activity (readiness-potential): The unconscious initiation of a freely voluntary act,” Brain, vol. 106, p. 623, 1983.
[2] B. Libet, “Unconscious cerebral initiative and the role of conscious will in voluntary action,” Behavioral and brain sciences, vol. 8, pp. 529-539, 1985.
[3] P. Haggard and M. Eimer, “On the relation between brain potentials and the awareness of voluntary movements,” Experimental Brain Research, vol. 126, pp. 128-133, 1999.
[4] A. Sirigu, E. Daprati, S. Ciancia, P. Giraux, N. Nighoghossian, A. Posada, and P. Haggard, “Altered awareness of voluntary action after damage to the parietal cortex,” Nature Neuroscience, vol. 7, pp. 80-84, 2003.
[5] H. Kornhuber and L. Deecke, “Hirnpotentialanderungen bei Willkurbewegungen und passiven Bewegungen des Menschen: Bereitschaftspotential und reafferente Potentiale,” Pflugers Archiv European Journal of Physiology, vol. 284, pp. 1-17, 1965.
[6] H. Shibasaki and M. Hallett, “What is the Bereitschaftspotential?,” Clinical Neurophysiology, vol. 117, pp. 2341-2356, 2006.
[7] C. Soon, M. Brass, H. Heinze, and J. Haynes, “Unconscious determinants of free decisions in the human brain,” Nature Neuroscience, vol. 11, pp. 543-545, 2008.
[8] I. Fried, R. Mukamel, and G. K, “Internally generated preactivation of single neurons in human medial frontal cortex predicts volition,” Neuron, vol. 69, pp. 548-562, 2011.
[9] M. Cerf, N. Thiruvengadam, F. Mormann, A. Kraskov, R. Quian Quiorga, C. Koch, and I. Fried, “On-line, voluntary control of human temporal lobe neurons,” Nature, vol. 467, pp. 1104-1108, 2010.
[10] T. Ball, M. Kern, I. Mutschler, A. Aertsen, and A. Schulze-Bonhage, “Signal quality of simultaneously recorded invasive and non-invasive EEG,” Neuroimage, vol. 46, pp. 708-716, 2009.
[11] G. Schalk, J. Kubanek, K. Miller, N. Anderson, E. Leuthardt, J. Ojemann, D. Limbrick, D. Moran, L. Gerhardt, and J. Wolpaw, “Decoding two-dimensional movement trajectories using electrocorticographic signals in humans,” Journal of Neural engineering, vol. 4, p. 264, 2007.
[12] O. Bai, V. Rathi, P. Lin, D. Huang, H. Battapady, D. Y. Fei, L. Schneider, E. Houdayer, X. Chen, and M. Hallett, “Prediction of human voluntary movement before it occurs,” Clinical Neurophysiology, vol. 122, pp. 364-372, 2011.
[13] O. Bai, P. Lin, S. Vorbach, J. Li, S. Furlani, and M. Hallett, “Exploration of computational methods for classification of movement intention during human voluntary movement from single trial EEG,” Clinical Neurophysiology, vol. 118, pp. 2637-2655, 2007.
[14] U. Maoz, A. Arieli, S. Ullman, and C. Koch, “Using single-trial EEG data to predict laterality of voluntary motor decisions,” Society for Neuroscience, vol. 38: p. 289.6, 2008.
[15] C. Camerer, Behavioral game theory: Experiments in strategic interaction: Princeton University Press, 2003.
[16] W. van de Grind, “Physical, neural, and mental timing,” Consciousness and cognition, vol. 11, pp. 241-264, 2002.
[17] W. P. Banks and E. A. Isham, “Do We Really Know What We Are Doing? Implications of Reported Time of Decision for Theories of Volition,” in Conscious will and responsibility, W. Sinnott-Armstrong and L. Nadel, Eds., ed: Oxford University Press, 2010, pp. 47-60.
[18] W. P. Banks and E. A. Isham, “We infer rather than perceive the moment we decided to act,” Psychological Science, vol. 20, p. 17, 2009.
[19] H. Lau, R. Rogers, and R. Passingham, “Manipulating the experienced onset of intention after action execution,” Journal of cognitive neuroscience, vol. 19, pp. 81-90, 2007.
[20] M. Matsuhashi and M. Hallett, “The timing of the conscious intention to move,” European Journal of Neuroscience, vol. 28, pp. 2344-2351, 2008.
[21] J. Miller, P. Shepherdson, and J. Trevena, “Effects of Clock Monitoring on Electroencephalographic Activity,” Psychological Science, 2010.
[22] H. C. Lau, R. D. Rogers, and R. E. Passingham, “On measuring the perceived onsets of spontaneous actions,” Journal of Neuroscience, vol. 26, p. 7265, 2006.
[23] G. B. Rollman, “Sensory events with variable central latencies provide inaccurate clocks,” Behavioral and brain sciences, vol. 8, pp. 551-552, 1985.
[24] J. D. Haynes, “Decoding and predicting intentions,” Annals of the New York Academy of Sciences, vol. 1224, pp. 9-21, 2011.
[25] P. Haggard, “Decision Time for Free Will,” Neuron, vol. 69, pp. 404-406, 2011.
[26] J.-D. Haynes, “Beyond Libet,” in Conscious will and responsibility, W. Sinnott-Armstrong and L. Nadel, Eds., ed: Oxford University Press, 2011, pp. 85-96.

1. A method for obtaining a separation time window used for real-time prediction of one of two actions, the method comprising:
providing a plurality of transducers configured to collect an activity;
coupling the plurality of transducers to a source of the activity;
based on the coupling, capturing, through a computer, for each transducer of the plurality of transducers an electrical signal in correspondence of the activity prior to an action onset, wherein the action can be a first action or a second action associated to the activity;
continuing capturing through the computer the electrical signal until the action is observed;
recording the action through the computer;
repeating the capturing, continuing and recording;
based on the repeating, collecting, through the computer, a plurality of captured electrical signals for each transducer;
based on the collecting, filtering, through the computer, the plurality of captured electrical signals for each transducer;
based on the filtering and the recording, detecting, through the computer, for each transducer a plurality of separation time windows in correspondence of the first action and the second action;
based on the detecting, eliminating, through the computer, one or more separation time windows shorter than a corresponding minimum desired time; and
based on the eliminating, obtaining, through the computer, for each transducer one or more separation time windows, wherein each separation time window is larger than the corresponding minimum desired time.

2. A method for obtaining a plurality of electrode/time window/classifiers for real-time prediction of one of two actions, the method comprising:
providing, through a computer, a plurality of binary classifiers;
obtaining, through the computer, a plurality of separation time windows in correspondence of a plurality of transducers according to the method of claim 1;
based on the obtaining, obtaining, through the computer, a set of electrode-windows;
dividing, through the computer, the set of electrode-windows into a training set of electrode-windows and a testing set of electrode-windows, wherein the training set is in correspondence of separation time windows farther to the action onset and the testing set is in correspondence of separation time windows closer to the action onset;
training, through the computer, the plurality of classifiers using the training set of electrode-windows;
based on the training, testing, through the computer, the plurality of classifiers using an internal cross-validation procedure on the testing set of electrode-windows;
based on the testing, obtaining, through the computer, a prediction accuracy for each classifier of the plurality of classifiers; and
based on the obtained prediction accuracy, obtaining, through the computer, a plurality electrode/time window/classifiers from the plurality of classifiers wherein each of the plurality of electrode/time window/classifiers has a prediction accuracy above a desired prediction accuracy over the testing set of electrode-windows.

3. A real-time method for predicting one of two actions associated to an activity, the method comprising:
obtaining, through a computer, a plurality of electrode/time window/classifiers according to the method of claim 2;
assigning, through the computer, a weight to each of the plurality of electrode/time window/classifiers;
providing, through the computer, a prediction time configured to be smaller than the time to the action onset, wherein the prediction time and the time to the action onset are in relation to a start of capturing time;
waiting for the start of capturing time;
capturing, through the computer, for each transducer of the plurality of transducers an electrical signal in correspondence of the activity prior to the action onset;
continuing capturing till the prediction time;
based on the capturing and the plurality of separation time windows, obtaining, through the computer, a plurality of electrode-windows;
testing, through the computer, the plurality of electrode/time window/classifiers on the plurality of electrode windows;
based on the testing, generating, through the computer, a prediction for each of the electrode/time window/classifiers of the plurality of electrode/time window/classifiers; and
based on the generating and the assigning, deriving, through the computer, a final action prediction, wherein the final action prediction predicts one of two actions prior to the action onset.

4. The real-time method of claim 3, wherein the assigning is in correspondence of a performance on prior predictions, the method further comprising:
waiting for the action onset;
observing the action;
recording, through the computer, the observed action;
comparing, through the computer, the action to the prediction for each of the electrode/time window/classifiers of the plurality of electrode/time window/classifiers;
based on the comparing, increasing, through the computer, an assigned weight if a corresponding electrode/time window/classifier of the plurality of electrode/time window/classifiers predicted the action correctly; and
based on the comparing, decreasing, through the computer, an assigned weight if a corresponding electrode/time window/classifier of the plurality of electrode/time window/classifiers predicted the action incorrectly.

5. The real-time method of claim 3, wherein the deriving of the final action prediction further comprises:
assigning, through the computer, for each electrode/time window/classifier of the plurality of electrode/time window/classifiers a prediction value +1 to a first action prediction and a prediction value −1 to a second action prediction;
multiplying, through the computer, the prediction value for each electrode/time window/classifier of the plurality of electrode/time window/classifiers by a corresponding assigned weight;
based on the multiplying, obtaining, through the computer, a weighted prediction value for each electrode/time window/classifier of the plurality of electrode/time window/classifiers;
summing, through the computer, the weighted prediction values of the plurality of electrode/time window/classifiers;
based on the summing, obtaining, through the computer, a final weighted prediction value;
comparing, through the computer, the final weighted prediction value to a drop-off threshold value, wherein the drop-off threshold value is a positive number;
declaring, through the computer, the final action prediction undetermined if the absolute value of the final weighted prediction value is smaller than the drop-off threshold value;
declaring, through the computer, the first action as the final action prediction if the absolute value of the final weighted prediction value is larger than the drop-off threshold value and the value of the final prediction value is positive;
declaring, through the computer, the second action as the final action prediction if the absolute value of the final weighted prediction value is larger than the drop-off threshold value and the value of the final prediction value is negative; and
deriving, through the computer, the final action prediction based on the declaring and declaring and declaring.

6. The real-time method of claim 4, wherein the deriving of the final action prediction further comprises:
assigning, through the computer, for each electrode/time window/classifier of the plurality of electrode/time window/classifiers a prediction value +1 to a first action prediction and a prediction value −1 to a second action prediction;
multiplying, through the computer, the prediction value for each electrode/time window/classifier of the plurality of electrode/time window/classifiers by a corresponding assigned weight;
based on the multiplying, obtaining, through the computer, a weighted prediction value for each electrode/time window/classifier of the plurality of electrode/time window/classifiers;
summing, through the computer, the weighted prediction values of the plurality of electrode/time window/classifiers;
based on the summing, obtaining, through the computer, a final weighted prediction value;
comparing, through the computer, the final weighted prediction value to a drop-off threshold value, wherein the drop-off threshold value is a positive number;
declaring, through the computer, the final action prediction undetermined if the absolute value of the final weighted prediction value is smaller than the drop-off threshold value;
declaring, through the computer, the first action as the final action prediction if the absolute value of the final weighted prediction value is larger than the drop-off threshold value and the value of the final prediction value is positive;
declaring, through the computer, the second action as the final action prediction if the absolute value of the final weighted prediction value is larger than the drop-off threshold value and the value of the final prediction value is negative; and
deriving, through the computer, the final action prediction based on the declaring and declaring and declaring.

7. The real-time method of claim 3, wherein the eliminating one or more separation time windows shorter than the corresponding minimum desired time further comprises:
combining, through the computer, any two or more separation time windows of the one or more separation time windows if the two or more separation time windows are less than a combining time distance apart;
based on the combining, integrating, through the computer, a normalized relative left/right separation function over each separation time window;
based on the integrating, obtaining, through the computer, an integration value for each separation time window; and
based on the obtaining, eliminating, through the computer, any one or more separation time windows with integration values smaller than a desired value, wherein the desired value defines the corresponding minimum desired time.

8. The real-time method of claim 7 further comprising a plurality of computer-based classifier learning algorithms used for the plurality of binary classifiers, the plurality of computer-based classifier learning algorithms comprising a combination of: a) shape-based, b) linear-support vector machine, and c) k-nearest neighbors with Euclidean distance, learning algorithm.

9. The real-time method of claim 8, wherein the shape-based learning algorithm tests, through the computer, whether a signal in correspondence of an action to be predicted is more similar to a mean measure of a previous first action signal versus a mean measure of a previous second action signal, with the measure being one of: a) median, b) mean, c) overall L1 norm, d) overall L2 norm, and e) overall convexity or concavity.

10. The real-time method of claim 9, wherein the plurality of computer-based classifier learning algorithms used for the plurality of binary classifiers comprise: a) a shape-based classifier using the median measure, b) a shape-based classifier using the mean measure, c) a shape-based classifier using the overall L1 norm measure, d) a shape-based classifier using the overall L2 norm measure, e) a shape-based classifier using the overall convexity or concavity measure, f) the linear-support vector machine, and g) the k-nearest neighbors with Euclidean distance.

11. The real-time method of claim 10 further comprising seven computer-based binary classifiers using the computer-based classifier learning algorithms a) through g) respectively.

12. The method according to claim 3, wherein the source of the activity is a brain of a patient and wherein coupling of a transducer of the plurality of transducers to the brain of the patient is performed intracranial.

13. The method according to claim 12 wherein the transducer of the plurality of transducers is an electrode being adapted to detect an electrical signal in correspondence of brain activity.

14. The method according to claim 10, wherein the source of the activity is a brain of a patient and wherein coupling of a transducer of the plurality of transducers to the brain of the patient is performed intracranial.

15. The method according to claim 14, wherein the transducer of the plurality of transducers is an electrode being adapted to detect an electrical signal in correspondence of brain activity.

16. The method according to claim 15, wherein capturing for each transducer of the plurality of transducers an electrical signal in correspondence of the brain activity further comprises:
based on the coupling of a transducer to the brain, receiving an electrical signal in correspondence of the brain activity;
based on the receiving, amplifying the electrical signal;
based on the amplifying, filtering the amplified signal;
based on the filtering, digitize the filtered signal;
based on the digitized signal, down sample the digitized signal; and
capturing the electrical signal by storing in a buffer memory the down sampled digital signal.

17. The method according to claim 3, wherein capturing for each transducer of the plurality of transducers an electrical signal in correspondence of the activity further comprises:
based on the coupling of a transducer to the source of the activity, receiving, through the computer, an electrical signal in correspondence of the activity;
based on the receiving, amplifying, through the computer, the electrical signal;
based on the amplifying, filtering, through the computer, the amplified signal;
based on the filtering, digitizing, through the computer, the filtered signal;
based on the digitized signal, down sampling, through the computer, the digitized signal; and
capturing, through the computer, the electrical signal by storing in a buffer memory the down sampled digital signal.

18. The method according to claim 3, wherein filtering the plurality of captured electrical signals for each transducer further comprises filtering, through the computer, of said signals within one or more frequency bands of interest.

19. The method according to claim 18, wherein a frequency band of interest comprises the frequency range 0.1 Hz to 5 Hz.

20. The method according to claim 19, wherein a computer-based second-order zero-lag elliptic filter with an attenuation of 40 dB is used for the filtering.

21. The method according to claim 15, wherein filtering the plurality of captured electrical signals for each transducer further comprises filtering, through the computer, of said signals within one or more frequency bands of interest.

22. The method according to claim 21, wherein a frequency band of interest comprises the frequency range 0.1 Hz to 5 Hz.

23. The method according to claim 22, wherein a computer-based second-order zero-lag elliptic filter with an attenuation of 40 dB is used for the filtering.

24. The method according to claim 23, wherein the first action comprises a left hand movement of the patient and the second action comprises a right hand movement of the patient.

25. The method according to claim 3, wherein the source of the activity is a brain of the patient and wherein the first action comprises a left hand movement of the patient and the second action comprises a right hand movement of the patient.

26. The method according to claim 13, wherein the first action comprises a left hand movement of the patient and the second action comprises a right hand movement of the patient.

27. A computer-based on-line real-time (ORT) prediction system for predicting one of two actions based on motor-preparatory brain activity, comprising:
a plurality of electrodes coupled to a brain of a patient, wherein the plurality of electrodes are adapted to detect electrical signals from the brain of the patient; and
a computer comprising a processor, wherein the computer is electrically coupled to the plurality of electrodes and wherein the computer further comprises a program code adapted to run the method according to claim 3 in real-time based on the detected electrical signals by the plurality of electrodes.

28. A computer-based on-line real-time (ORT) prediction system for predicting one of two actions based on motor-preparatory brain activity, comprising:
a plurality of electrodes coupled to a brain of a patient, wherein the plurality of electrodes are adapted to detect electrical signals from the brain of the patient; and
a computer comprising a processor, wherein the computer is electrically coupled to the plurality of electrodes and wherein the computer further comprises a program code adapted to run the method according to claim 7 in real-time based on the detected electrical signals by the plurality of electrodes.

29. A computer-based on-line real-time (ORT) prediction system for predicting one of two actions based on motor-preparatory brain activity, comprising:
a plurality of electrodes coupled to a brain of a patient, wherein the plurality of electrodes are adapted to detect electrical signals from the brain of the patient; and
a computer comprising a processor, wherein the computer is electrically coupled to the plurality of electrodes and wherein the computer further comprises a program code adapted to run the method according to claim 10 in real-time based on the detected electrical signals by the plurality of electrodes.

30. A computer-based on-line real-time (ORT) prediction system for predicting one of two actions based on motor-preparatory brain activity, comprising:
a plurality of electrodes coupled to a brain of a patient, wherein the plurality of electrodes are adapted to detect electrical signals from the brain of the patient; and
a computer comprising a processor, wherein the computer is electrically coupled to the plurality of electrodes and wherein the computer further comprises a program code adapted to run the method according to claim 11 in real-time based on the detected electrical signals by the plurality of electrodes.

31. A computer-based on-line real-time (ORT) prediction system for predicting one of two actions based on motor-preparatory brain activity, comprising:
a plurality of electrodes coupled to a brain of a patient, wherein the plurality of electrodes are adapted to detect electrical signals from the brain of the patient; and
a computer comprising a processor, wherein the computer is electrically coupled to the plurality of electrodes and wherein the computer further comprises a program code adapted to run the method according to claim 20 in real-time based on the detected electrical signals by the plurality of electrodes.

32. The computer-based ORT prediction system of claim 31 adapted to predict left hand movement of the patient and right hand movement of the patient.

33. A computer-based on-line real-time (ORT) prediction system for predicting one of two actions associated to an activity, comprising:
a computer comprising a processor, wherein the computer is electrically coupled to a plurality of transducers and wherein the computer further comprises a program code adapted to run the method according to claim 3 in real-time based on a plurality of detected electrical signals by the plurality of transducers.

34. A computer-based on-line real-time (ORT) prediction system for predicting one of two actions associated to an activity, comprising:
a computer comprising a processor, wherein the computer is electrically coupled to a plurality of transducers and wherein the computer further comprises a program code adapted to run the method according to claim 7 in real-time based on a plurality of detected electrical signals by the plurality of transducers.

35. A computer-based on-line real-time (ORT) prediction system for predicting one of two actions associated to an activity, comprising:
a computer comprising a processor, wherein the computer is electrically coupled to a plurality of transducers and wherein the computer further comprises a program code adapted to run the method according to claim 10 in real-time based on a plurality of detected electrical signals by the plurality of transducers.

36. A computer-based on-line real-time (ORT) prediction system for predicting one of two actions associated to an activity, comprising:
a computer comprising a processor, wherein the computer is electrically coupled to a plurality of transducers and wherein the computer further comprises a program code adapted to run the method according to claim 11 in real-time based on a plurality of detected electrical signals by the plurality of transducers.
